(19) United States
(12) Patent Application Publication
(10) Pub. No.: US 2011/0010448 A1
(43) Pub. Date: Jan. 13, 2011

(54) LEVERAGING AND INFLUENCING COMPUTING NETWORK ACTIVITY

(76) Inventors: Paramjit S. Gill, Ottawa (CA); Randall W. Marusyk, Ottawa (CA); Chung Ming Tam, Ottawa (CA); Barjinderpal P. Gill, Los Gatos, CA (US); Stefan H. Van Kessel, Ottawa (CA)

Correspondence Address: MBM Intellectual Property Law LLP, 270 ALBERT STREET, 14TH FLOOR, OTTAWA, ON, K1P 5G8, CA

(21) Appl. No.: 12/739,061

(22) PCT Filed: Oct. 22, 2008
(86) PCT No.: PCT/CA08/01822

§ 371 Date: Apr. 21, 2010

Related U.S. Application Data
(60) Provisional application No. 60/981,773, filed on Oct. 22, 2007.
(60) Provisional application No. 60/981,781, filed on Oct. 22, 2007.

(51) Int. Cl. G06F 15/173

(52) U.S. Cl. 709/224

(57) ABSTRACT

A system and method for associating benefit with the activities of a computing system, and for influencing the behaviour of users of the computing system, the system and method comprising a computing system having one or more subseribable actions, optionally associated with the functionality of the computing system; optionally, a means for associating additional information, activity or events with one or more of the one or more subseribable actions, the additional information, activity or events being associated with one or more third parties; a means for detecting and recording information relating to activity that is related to: the one or more subscribable actions, the one or more first users triggering the one or more subscribable actions, or a combination thereof; and optionally, a means for communicating or making available to one or more second users information relating to: the subseribable action, the one or more first users and, if necessary, the associated information, activities or events.

### FIELD OF THE INVENTION

The present invention pertains to systems to leverage and influence network activity. The present invention also involves a system for generating advertising or marketing dollars using software with a particular focus on software that are applied to social networks.

### BACKGROUND

A general problem for the software industry is the ability to capture value for the software owner while at the same time reducing the barrier of adoption for the user. There are historically three ways in which a System Administrator can capture value for the software: through sales, advertising revenue or accept alternative measure of returns.

Traditionally, the software sales model is similar to other commodity-based industry, in that it is brought or purchased like any commodity or service with payment going to the owners of the software (Campbell-Kelly and Aspray, 2004). Setting the appropriate price point for the software becomes the dominant issue as expensive software raises the barrier to entry. Shareware represents one alternative distribution-payment model that allows users to try the software for a trial period before the user pays the required fees in order to continue to use the software (Albert et al., 1999). As a result, cost of the software as the initial barrier for adaptation has been reduced,

Advertising based software displays advertising while the user is using the software (Petrecca et al. 1995; Horstmann, 1998; Choi, 2000). For software whose revenue streams are based on advertising, the System Administrator may be paid by a Third Party, commonly referred to as advertisers or marketers (National Research Council, 2000). As a result, there are no price related barriers for adaptation but this model creates other problems such as usability and intrusiveness for the end user (Deswarte et al., 2004). Additional problems encounter in this traditional advertising supported software is the lack of response to those ads (Shen, 2005). A potential solution is to use an algorithmic technique to choose and target the potential user base to improve the success of those ads (Dadush, 2005) but this approach still does not solve the problem of quantifying the value of the advertising to the Third Party.

Freeware and open source software is another distribution model that requires no payment of fees from the user (Feller et al., 2005) thus reducing the barrier to entry. In this case, the software owner generates value indirectly. This indirect value may be generated by, among other ways, increase in goodwill due to altruistic behaviour, increased recognition, or by offering support, warranties, or customization.

Current distribution methods represent a trade-off between capturing a tangible value for the software owner and reducing the barrier of entry for a user. For example, a high software price can result in a high barrier for entry in contrast free software does not return tangible value back to the software owner. Advertising based software has a potential of reducing or eliminating the price barrier but introduces the additional problem of returning value to a third party the advertiser.

Software applications become more pervasive and powerful when they exist in a communication network such as the Internet. However, the System Administrator faces the same problems in trying to capture value for their software application. The ability to provide a measured response from networked software applications offers tremendous value to an advertiser. For example, by being connected to a network environment, software advertising becomes interactive so that advertising can be acquired from the network (Hoyle, 1998). Another example is the delivery of context sensitive advertising based on the display of text within a webpage (Green and Schroder, 2004). However, those approaches do not solve the problem of reducing the barrier to entry or enticing the user to carry out an action desired by the advertiser.

Social networks and online communities are a special type of network created through an association of people drawn together through their interactions and activities over a communication network (Acquisti, 2007). One benefit to social networks is that they reduce the barrier to entry for using software because by its nature, such networks promote similar actions and behaviour amongst an individual's pre-existing social links. Prior art deals with the issues of how online communicates can be created based on the network activities (Elder et al., 2007) and the need to monitor the level of activities in order to maintain such networks (Castellani et al., 2004). There has also been work on defining the type activities that can occur within such networks. For example, in a special case of social networks where the members have a pre-existing and defined social relationship, the resulting social network acts as a flexible control mechanism for activities occurring within this network (Tam et al., 2006). The problem remains for social networks is how System Administrator s can gain value from creating applications in social networks.

A system of software distribution and payment system that seeks to reduce the price-based barrier for entry and provides measurable values to third parties (i.e., a party other than the end user and the developer) is not known in the art. Further, a new system that creates a distribution mechanism that provides tangible value back to the software owner using an advertising payment system is not known in the art. A system in which a user does not need to pay for using the software would effectively reduce barriers to entry. The value of such a system could be derived from third party sponsorships that pay the software owner for the user undertaking any of a set of verifiable actions that are integral to the design and operation of the system. Value to the third party would be available for and from the action of a user while the user is using the software, and in particular for the one or more verifiable actions. This is distinctively different from that current advertising based model where an advertiser is paying for the passive display of an graphic or text and then relying on the user to perform an action based on the this display (for example, to click on a hyperlink based on a text advertisement). In the traditional advertising model, the action is not guaranteed but in this new system, the action is guaranteed.

Having this process applied to a specific type of communication network—a social network—is also unknown in the art and could possibly increase value to a third party by allowing peers to influence and increase network or software system activity, while still reducing barriers to entry. Such a system and/or method could explicitly encourage activity on any social network or online communities. By using such a system and method, an interested third party has the ability to encourage desired activities or reduce or eliminate unwanted actions on individuals using a software application.

### SUMMARY OF THE INVENTION

An object of the invention is to provide a system and method to leverage and influence activity on computing systems and networks

In accordance with one aspect of the invention, there is provided a system for associating benefit to activities of a computing system comprising a computing system having one or more subscribable actions, each subscribable action associated with one or more functionalities of the computing system; means for associating one or more party parameters with any of the one or more subscribable actions, the one or more party parameters being associated with one or more third parties; and means for detecting when a subscribable action has been triggered by one ore more first users; and means for recording information relating to triggered subscribable actions comprising: the one or more subscribable actions, the one or more first users or a combination thereof.

In accordance with another aspect of the invention, there is provided a system for influencing behaviour of one of more second users of a computing system comprising a computing system having one or more subscribable actions; means for detecting when any of the one or more subscribable actions is triggered by one or more first users; and means for communicating or making available to the one or more second users of the computing system information relating to: the one or more first users, the associated subscribable action, or a combination thereof.

In accordance with another aspect of the invention, there is provided a method for associating benefit to activities of a computing system comprising providing to one or more first users access to a computing system having one or more subscribable actions, each subscribable action associated with one or more functionalities of the computing system; associating one or more party parameters with any of the one or more subscribable actions, the one or more party parameters being associated with one or more third parties; detecting when a subscribable action is triggered by the one or more first users; and recording information relating to the one or more subscribable actions, information relating the one or more first users, and information relating to the one or more associated party parameters.

In accordance with another aspect of the invention, there is provided a method for influencing behaviour of the users of a computing system comprising, the method comprising the steps of providing a computing system having one or more subscribable actions; detecting when a subscribable action is triggered and recording information relating to the subscribable action and the one or more users that triggered the subscribable action; and communicating or making available to one or more second users information relating to: the one or more first users of the computing system, the subscribable action, or a combination thereof.

A system is provided that permits a system implementer, administrator, owner, or developer to generate revenue from Third Party when a user uses the system. In such a system, one of more “Subscribed actions” can be sponsored and paid for by a Third Party. When applied to a social network, the process and method can be used to influences behaviour of members within such networks.

### BRIEF DESCRIPTION OF THE FIGURES

FIG. 1 depicts a flow chart representative of a system and/or method for leveraging software system or network use by assigning value to subscribed actions, in accordance with one embodiment of the present invention.

FIG. 2 depicts a system diagram representing an implementation of the system and method of FIG. 1 by one or more computers and one or more communication systems, in accordance with one embodiment of the present invention.

FIG. 3 depicts a flow chart representing the system and method of FIG. 1 within the context of a social network, in accordance with one embodiment of the present invention.

FIG. 4 depicts a system network of the system and method of FIG. 3 showing various network components involved and information flows, in accordance with an embodiment of the present invention.

### DETAILED DESCRIPTION OF THE INVENTION

The present invention provides a system for leveraging and influencing activity on software systems and social networks. Software systems, including those that operate with or as social networking systems, include one or more actions by Users that is intrinsic to the software system and are necessary in order for the software system to carry out its desired functions. In the present invention, information or behaviour that may have value for a Third Party can be associated with these actions, which can be subscribed actions. Examples of the subscribed actions in some embodiments may activity such as entering a user name, or password, operating user verification applications (e.g. CAPTCHA), selecting hyperlinks, sending or receiving information, logging on or off, or any other activity that is intrinsic to the operation of a software system or social network. The information or behaviour that has value and that can be associated with the one or more subscribed actions may include viewing advertising, selecting a user name or password that is associated with a third party, using Captcha identifiers associated with a Third Party, providing an option to direct web traffic or visits to a particular site, or any other activity that would be known to a person skilled in the art. The one or more subscribed actions that are intrinsic to the operation of the software system or social network can be provided with additional actions, behaviour, user options or information, etc., that is associated with a Third Party. This association, and the further actions, behaviour, user options or information, etc., can be verified and documented.

While the subscribed actions can be implemented on any software system, social networks on a communication media (e.g. the internet) provide additional means to provide value for the associated value-added activity. Some members or peers of a particular social network may have varying degrees of influence over other members or peers of the particular social network. Accordingly, having verifiable and documented activity, that provides value to a Third Party, that may be associated with a particular member or peer of a social network, and making this information available to other members of a social network can influence the behaviour of all the members. This functionality goes beyond tracking how many items have been sold or items that are typically bought at the same time (e.g., people who bought book A, also bought book B), the activity of specific influential peers, or class thereof, is also leveraged in some embodiments of the instant invention. An influential peer may be, among others, another peer's friend, a very popular peer, a well known peer, or a peer with many credentials in a particular art or science.

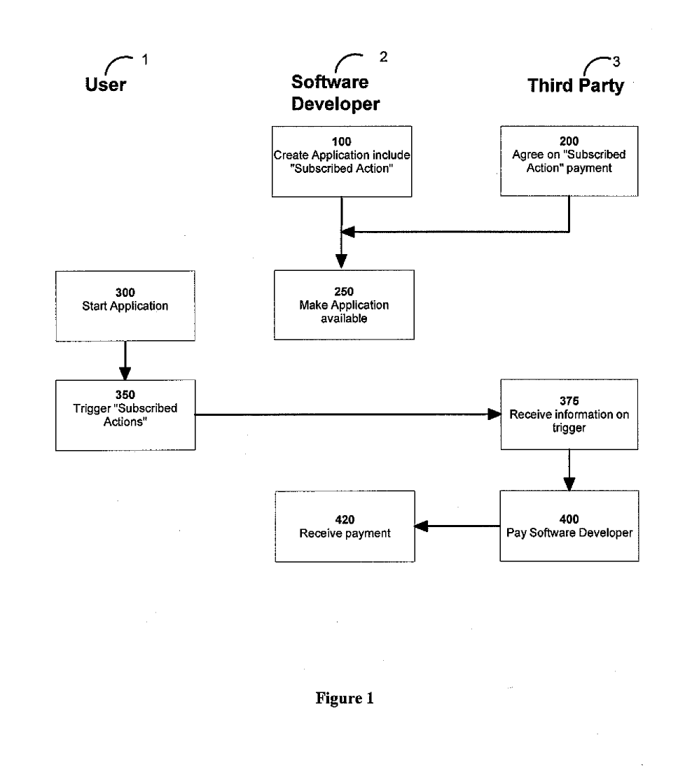

With reference to FIG. 1, which shows an embodiment of the system and method of the instant invention, the actions of three groups are described: the User (1), the System Administrator (2) and a Third Party (3). The User (1) by definition can be any individual that uses a software application or engages in social networking. The System Administrator (2) is defined as the entity that administers, manages, owns, develops or otherwise oversees a software application or network. The only specification for the software application is that it provides one or more activities, the “Subscribed Action,” that the Third Party can associate with value and there is some proof that such an event has taken place. The Third Party (3) is someone that agrees to pay for this action carried out by a user of the software.

The System Administrator (2) can be defined as any person or computing device that administers, manages, owns, develops, creates, produces, controls, markets, sells, promotes, or any combination thereof, one ore more computing or software systems, software applications (100) networks, or combinations thereof, that contain one or more “Subscribed Actions”. A “Subscribed Action” is defined as an action that is an integral part of the software system or network operation such that the user must encounter and execute this action in the ordinary course of using the software system or network. The System Administrator then arranges that the Third Party (3) to pay for each “Subscribed Action” (200). Certain parameters relating to the third party may be associated with the “Subscribed Action”, which may include among other things, promotional names or material, linkage or directing to a additional web sites, or the triggering of certain events advantageous to the Third Party. There can be one or more Third Parties for one or more “Subscribed Actions” within each software application. Once this agreement is reached, the System Administrator can then make the Application (4) available to the user (250).

The User (1) is an individual that uses the software. The User starts the Application (300) and through the use of the software, triggers one or more “Subscribed Action” (350). Once this occurs, information is transferred over the network to the Third Party (375). The Third Party then pays the System Administrator (400).

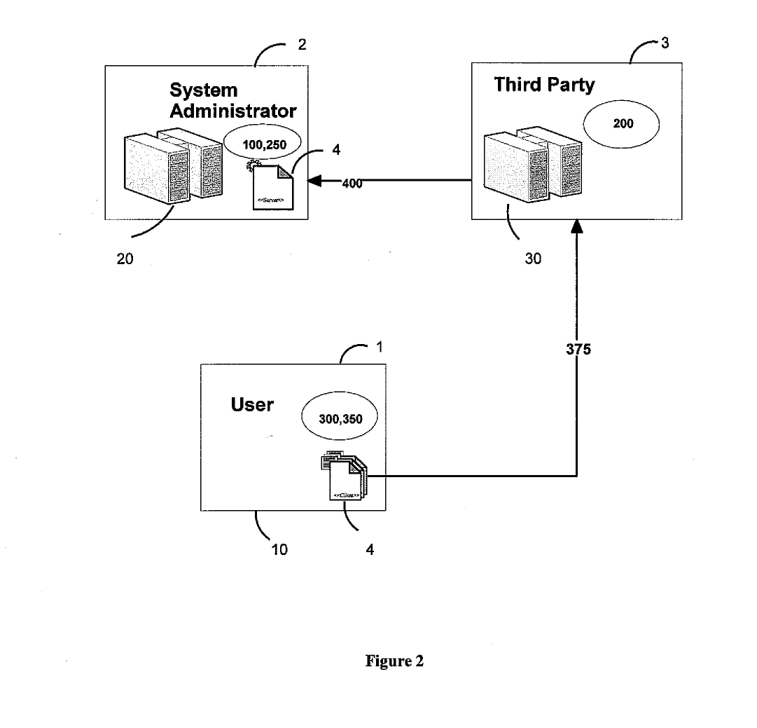

FIG. 2 is a system diagram representing this process. In FIG. 2, the System Administrator uses a computer and communication system (20) to develop a software application (4). The software application can be based on any computer architecture such as client-server, peer-to-peer or other types of software system and network configurations known in the art, such as a “cloud” configuration and hybrid client-server/peer-to-peer configuration. The software application must contain one or more subscribed actions (100). One or more computers and communication systems (3) may be used to record information on the “Subscribed Action” and agreed to pay the System Administrator for each instance of the “Subscribed Action” (200).

The User (1) uses a computer and communication system (10) to carry out the operations of the software (4). The user starts the application (300) and triggers a “Subscribed Action” in the software (350). This information is sent to the Third Party (375) who can then pay the System Administrator (400).

The value and capability of this system and method is increased when the system and method is applied to a network and especially to a social network. In this case, the actions of a user using the software can influence the actions of other users within the same social network. The process is similar to the general case of dealing with software applications.

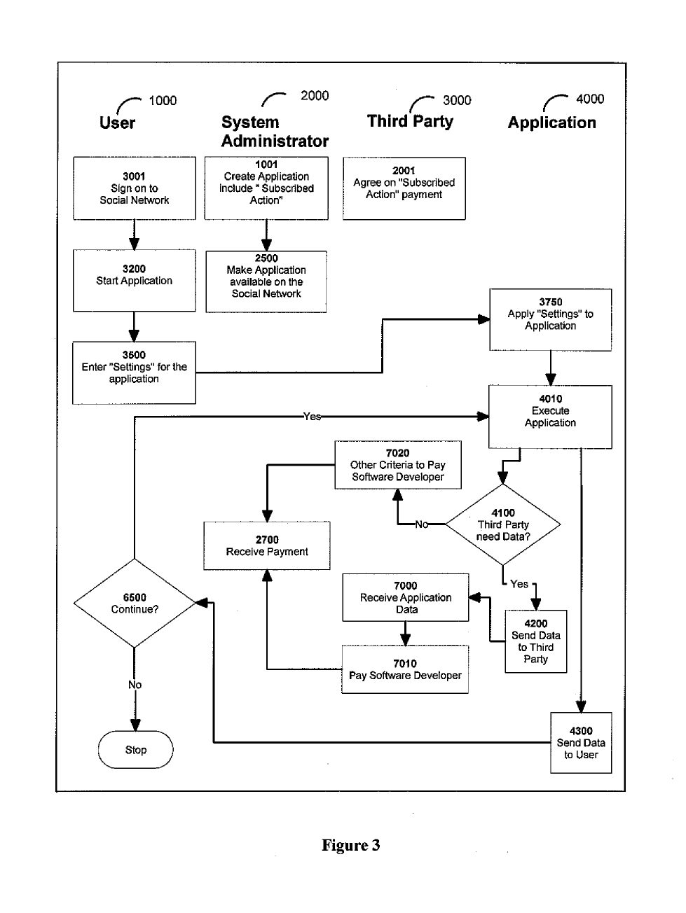

FIG. 3 is a flow chart describing the system and method as applied in a social network. The three groups: the User (1000), the System Administrator (2000),

Third Party (3000) and the Application (4000) are effectively the same as in the general case for any software application. The User (1000) may be an individual that uses the software application within or outside of a social network, or alternatively any other type of user such as automated users like bots or crawlers. The System Administrator (2000) is defined as the entity that creates the software Application (4000) containing one or more “Subscribed Action” and the application are designed to work within a social network. The only additional specification for the software application (4000) is that it contains parameters so that the user can control the network behaviour of the software. The Third Party (3000) is defined as someone that has a vested interest in the action of the application and the use of this application within the online community. The “Subscribed Action” can encourage or discourage types of behaviour based on the use within the community. The activity of certain members may play a role in the encouragement or discouragement of the “subscribed activity”.

In FIG. 3, the System Administrator (2000) administers, manages, owns, develops or otherwise oversees a computer application (1001) for a social network or online community. This Application (4000) is a set of computer instructions that facilitates one or more activity for a user on a social network or within an online community. An example of such an activity is communication or information sharing for members within a social network. The distinction in this Application (4000) is the inclusion of two features: the ability for the User (1000) to control their “Settings” and the ability for a Third Party (3000) to pay for the use of one or more “Subscribed Action” within the Application (4000). “Settings” are by definition a method for the User (1000) to control the actions of the Application (4000). The System Administrator (2000) makes the Application (4000) available to the Social Network (2500).

The User (1000) signs on to a Social Network (3001). Examples of Social Networks include but are not limited to public social networks such as Facebook or Myspace. The User (1000) then starts the Application (3200). User (1000) then enters their “Settings” for the Application (3500). “Settings” are parameters which the user can use to control some aspects of the Application. Typical settings include language controls or privacy controls.

The Application (4000) applies the “Settings” (3750) and carries out the programmed instructions based on the applied settings. During the execution of the Application (4010), one or more of the “Subscribed Action” are processed. The Application checks if data is required to be sent back to the Third Party (4100). If there is no requirement, then the Third Party must use some other criteria to pay the System Administrator (7020). An example of other criteria could be a time based system. If there is such a requirement, the appropriate data is sent back to Third Party (4200). The Third Party can take additional action after receiving these Application Data (7000) and then pays the System Administrator (7010). After performing the required task, the application sends data back to the user (4300) and the user can decide (6500) to continue with the application or stop the application.

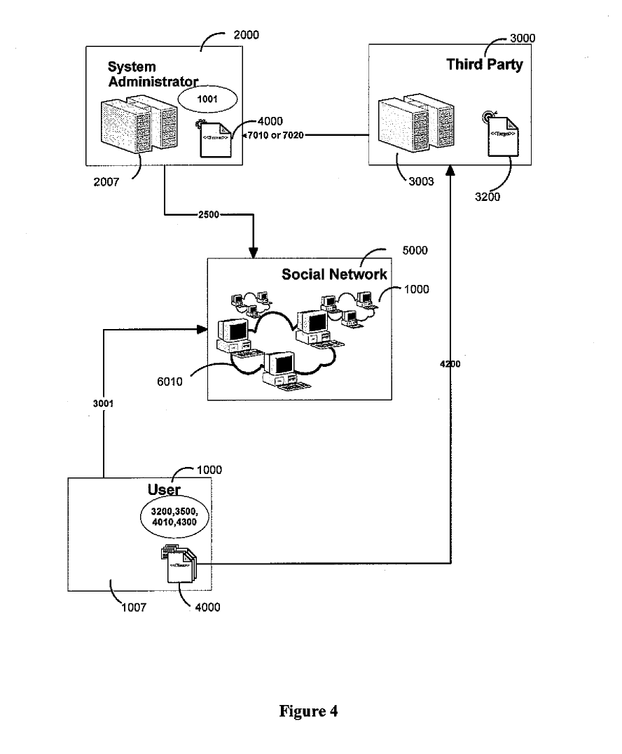

FIG. 4 represents a system network view of the process described in the flow chart (FIG. 3). The system network view provides information on the components involved in this process as well as the information flows that occur within the network. In FIG. 4, using the same nomenclature as the process flow chart, the role of the User (1000), System Administrator (2000) and the Third Party (3000) can be seen. The System Administrator (2000) works with a computing and communication system (2007) and creates the Application (4000) with one or more “Subscribed Action” (1001). In this process, there Application can be any type of computer program and is not limited to the type of computer architecture such as Client-Server architecture or Peer-to-Peer architecture but is designed to work within a Social Network (5000). The Third Party (3000) has a computing and communication system (3003) and a payment agreement (3200) with the System Administrator. The payment agreement specifies the terms of payment for each “Subscribed Action” perform by the User (1000) while the User (1000) is using the Application (4000). The System Administrator makes the Application (4000) available (2500) on a Social Network (5000).

A Social Network (5000) is a collection of Users (1000) having some type of relationship and can communicate with each other over a communication network (6010). Examples of a network could be the Internet or a telephone network. Examples of a Social Network are Facebook or MySpace. The requirement for a User (1000) is the use of a computing device (1007) and the ability to communicate with the Network (6010).

In this system, the User (1000) signs on to the Social Network (3001) and starts the Application (3200). The User (1000) carries out the instructions and activities provided by the Application (4000). For example, the User can enter the “Settings” (3500), perform an activity (4010) or receive data from the Application (4300). The Application (4000) will send data back to the “Third Party” if required (4200).

In one embodiment, the subscribed action includes the use of a CAPTCHA. A CAPTCHA or Captcha is a type of challenge-response test used in computing to ensure that the response is not generated by a computer. The process usually involves one computer (a server) asking a user to complete a simple test which the computer is able to generate and grade. Because other computers are unable to solve the CAPTCHA, any user entering a correct solution is presumed to be human. Thus, it is sometimes described as a reverse Turing test, because it is administered by a machine and targeted to a human, in contrast to the standard Turing test that is typically administered by a human and targeted to a machine. A common type of CAPTCHA requires that the user type the letters or digits of a distorted image that appears on the screen. The term “CAPTCHA” is used herein to refer to any type of was challenge-response test used in computing.

In some embodiments, an advertisement may be received, embedded in a CAPTCHA and stored for use in online advertising. A question about the advertisement may also be stored along with a valid answer for use in verifying a user has received an impression of the advertisement. In response to a request received for sending a CAPTCHA with an embedded advertisement to a web browser operating on a client, a CAPTCHA with an embedded advertisement may be selected and sent to the web browser for display as part of a web page. Upon verifying the response to the question from the user is a valid answer, receipt of an impression of the advertisement may be recorded. Additionally, the awareness of an online advertisement may be measured for a target audience and reported to the Third Party. In certain embodiments, a selection of CAPTCHA challenges may be presented to give the User an option as to which challenge to use. The use of a given challenge can result in some benefit to the User, such as an increase in points or notoriety. Use of a given challenge by a particular User, or class of User, or a User or Users having certain characteristics (i.e., popularity or fame) can be communicated to other members of the peer group in order to influence behaviour.

In particular, one embodiment of the present invention involves using an application in such a social network system such as FaceBook, MySpace, LinkedIn, ToPeer, (or any other electronic network that is based upon a trusted social network, including games (for example Halo3 and the like), messages (for example email, text, slogans, poems), actions (for example, clicking on a link, watching a video, exchanging electronic digital information, editing a video, giving a virtual gift, or whatever one skilled in the art could imagine).

A System Administrator of such an application, for example, could use PHP and MYSQL database or using FaceBook's API and PHP. The FaceBook API provides access to the social network, the PHP provides the interactive rules and regulation governing the application and the MYSQL governs the history and provide the data feeds (e.g. Images) to the FaceBook user.

In addition to the above point accumulation system, the present example could involve third party advertisement—where in one example, the virtual candy would be a well recognized candy bar such as a Snickers. The importance of such an exemplary embodiment to third party advertiser is that the social network facilitates the distribution of certain actions, or subscribed actions, taken by users of the application. An example of such certain action is the handling out of virtual Snicker bars to anyone within a given electronic based social network, or having any type of relationship with the user undertaking that action.

The term “points” could involve any point system including but not limited to Airmiles, shopping reward system, Points.com, airline point reward systems, hotel reward systems, or any loyalty based point system, such that one skilled in the art would recognized and include any such point system as applicable for use with the present invention.

In one embodiment, the system could involve a means for influence the selling of products and/or services by associating actions taken with other users having a pre-existing relationship or that fit a certain class of criteria (i.e., a user is a friend of a friend, is very popular amongst users of a community, is famous outside or independently of an online community or social network, among other possible examples). It could also be involved in a system that influence donations for charity or other community based initiatives such as fund raising events. It could also be used by advertisers to link products and/or services to the above described systems.

On embodiment of the present invention involves a system for selling that could involve a real or virtual store (a Nike store is an example of a real store and Amazon is an example of a virtual store), whereby an initial user purchases products and/or services and such purchasing information is used by said store to influence and cross promote further purchases by members of the initial users' social network.

A further embodiment may relate to the social network system FaceBook (e.g. the users Friend list is a social network). The initial user of FaceBook would install an application which would have links or search tools to locate any product and/or service of any kind. The initial user would then be taken to one or more sites (to do a straight purchase or would involve a system of links screens that allow for comparison shopping and purchase) that are linked to the search results. The initial user makes a purchase of said products and/or services and the social network within FaceBook is informed directly of indirectly of said purchase.

Directly being informed could involve a message being sent to all Friends of the initial users. Being informed indirectly could involve a further step(s) that would be similar to checking of “Friends of X”, as just one example of an indirect informed system. By having the purchasing activity of one member of the social network it will influence and encourage other members of that social network to follow the same purchasing pattern(s).

In one embodiment, someone within a given social network that may have purchasing influence is an individual that holds a particular expertise for a given product and/or service. It could be envisaged in one example, by one skilled in the art, that such an individual would be someone with a high degree of expertise in Plasma TVs. That individual's purchase would influence other member of the social network to purchase similar TVs given the social status of that individual in that area of product purchase.

A second example would involve a person of fame. Fame could be within a community or could be at the level of a superstar such as Paris Hilton or Brad Pitt. Anyone part of the social network of such user would see the purchasing patterns of that individual and would therefore be influenced by their fame and follow their purchasing pattern or recommendation.

If is envisaged that incentive programs could be integrated into the present invention in the form of a reward system that could involve the earning of points, priced reduction being granted to the initial user who influences others to purchase the same or similar product and/or services within their social network, or any other type of incentive or reward system that one skilled in the art would understand to function within this system. These incentives or reward could be structured as a multi-level marketing scheme that one skilled in the art would be familiar with.

Advertisers could also be involved in this process by having, for example, to take part within the system by providing an ad (e.g. a pop-up ad) for the advertiser's product and/or service during the purchasing process. Additionally, advertisers within a virtual store could use product and/or services placements such as on a virtual Plasma TV, displaying a given brand of a real plasma TV.

Furthermore, advertisers could further get involved in this process with paying to have their product and/or services involves with schemes known as “sponsored listing” or “premier placement” that typically arise from search results. The variations of paying for such schemes are well known to those skilled in the art for such advertising activity.

The present invention can applied to any form of virtual world that allows for purchasing, such as that found in SecondLife or other world known to one skilled in the art.

Unless defined otherwise, all technical and scientific terms used herein have the same meaning as commonly understood by one of ordinary skill in the art to which this invention belongs.

The invention will now be described with reference to specific examples. It will be understood that the following examples are intended to describe embodiments of the invention and are not intended to limit the invention in any way,

### Examples

### Example 1

### Website Authentication Process

The Marketing system for software and social network is applied in conventional software applications where the interactive steps within the operation software application become an opportunity for a Third Party to satisfy their marketing requirements.

In this example, the software application is a Website that has three “Subscribed action” of interest to Third Party—a repeated action that requires the recall of a specific string of text by a user.

System Administrator

A developer uses various technologies such as PHP, ASP, Java, HTML to create the Website that requires a series of steps to log in to the website. The “Subscribed Action” for this software application is:
1. UserID could be any length but must include the text string “XXXXX”
2. Password could be any length but must include the text string “YYYY”
3. CAPTCHA displays must include words picked randomly from a sponsor keyword database or a third party logo or picture. Some exemplary embodiments may include a variety of options of CAPTCHA displays, any one of which can be used for verification purposes.
4. Security questions are chosen from a list in a sponsor security questions database.

Third Party

One or more Third Party agreed on a payment process to the System Administrator based on the “Subscribed Action” carried out by a user using the application. Examples of such payment process include:
1. Payment A when the user enters a UserID that contains the string “XXXXX”.
2. Payment B when the user enters a password that contains the string “YYYY”.
3. Payment C when the user enters a CAPTCHA display with a particular keyword as defined by the Third Party
4. Payment D when the user selects and answers a particular sponsor security question.

User

A user of this software application will use the application accordingly. Following the function of the software, the User:
1. Enters a UserID that contains the string “XXXXX”.
2. Enters a password that contains the string “YYYY”.
3. Answers any one of the available CAPTCHA challenge by entering a keyword.
4. Answers a Third Party security question.

As a result of those User actions, each subscribed action triggers a payment (A, B, C, D) from the Third Party to the System Administrator. In addition, information regarding the UserID, the selected CAPTCHA challenge can be used to influence other peer members of the online community. A particular User, who is very popular and influential among the community, selecting a UserID and the available CAPTCHA challenge that is associated with the Third Party can influence the behaviour of other peers when those peers learn that this User (or alternatively a User that is popular and influential, but anonymous) carried out a particular action. In this example, peer members will be notified that a User, who is very popular but remains unnamed, chose to use a CAPTCHA challenge associated with the Third Party's logo.

### Example 2

### Trick or Treat Application

One example of such an embodiment is a software application developed within Facebook (a social network). The software application is named “Trick or Treat” and it is a system that allows users to trade virtual candy on the Facebook social network. In this example, we will describe the role of the System Administrator, the Sponsor, the User in this system and the uniqueness of the software according to this patent application.

While the present example describes a Halloween based theme of “trick or treat”, the present system for “Sponsorship-based Interactive Marketing systems” could be applied to any occasion or activity of any kind (birthdays, Christmas, Easter, Valentines Day and so on). This example could also include any product, service or activity that correspond to a particular occasion or activity and is deemed valuable from a sponsors' point of view.

System Administrator

A developer of such an application can use technologies such as PHP and My SQL database to work within the Facebook network. Alternatively, a developer can use the Facebook API (Application Program Interface) and PHP to create the functions required by the software application. PHP is a programming language that can be used to write the rules and regulations governing the application. MySQL database is a technology that could be used to control the user history and provide the data feeds such as images to the user of the application.

The “Trick or Treat” application is designed based on a set of “Subscribed Actions” in the application program. Examples of the “Subscribed Actions” are:
Images are created by the software application. The user can select and identify those images as “virtual candies” with specific properties and attributes. For example,
   An image represents a brand of candy or a type of candy determined from a Third Party
   A brand of candy is worth a certain reward points as defined by a Third Party.
Create a set of actions based on the transfer or exchange of those images:
   Assign a point system to an action. For example,
      Giving someone a brand or type of candy is X points.
      Obtaining a brand or type of candy is Y points.
      “Eating” a brand or type of candy is Z points.
      With points, X, Y, Z defined by the Third Party.
   For each user, the systems tracks the points accumulated based on the user's interaction with the application and with other users on Facebook using the virtual candy. For example, a user A using the software application have produce the following actions: 1) Give someone a candy, (2) receive a candy from a friend and (3) ate a candy, the application then records the point accumulation for the user A as Transaction=X+Y+Z.
   Assign a reward system based on the accumulation of transaction points. An example of the rule system will be that if a user achieves Q amount of reward points the user will automatically receive R amount of real candy from a Third Party.

Third Party

A Third Party will agreed on a payment process to the Software owner based on specific actions carried out by the user using the application. Examples of such payment process include:
Fixed payment for using an image to represent a specific brand of candy.
A payment schedule based application transactions. For example,
   A payment that is a function of the number of users and/or the number virtual candy available in the system at a particular time.
   A payment based on the number or type of candy being “eaten”.
An exchange of goods based on application transactions. For example,
   An exchange of real goods provided by the sponsor based on reward points accumulated by an user.

User

A user of this “Trick or Treat” application will find and install this application when the user is on the Facebook network. The user will use the application as developed by the System Administrator s to exchange virtual candy with their friends and as a result, payment is made from the Third Party to the System Administrator.

### Example 3

### Virtual Stores in Virtual Worlds

In this example, the software application is a “Virtual Store” in a computer network such as Second Life. Second Life is one of the more popular types of virtual worlds—a computer-based simulation that allows users to interact via a graphical interface. The roles of the Developer, Sponsor and the User in a “Sponsorship-based Interactive Marketing Systems” will be described as follows:

System Administrator

A developer using technologies such as the Linden Scripting Language (LSL) which are compatible with the Second Life platform to create a software application known as a “Virtual Store”.

The “Virtual Store” application is designed based on a set of rules and codified in the application program. Examples of the types or rules are:
The application exists within the Second Life network and obeys the rules and regulations governing this network.
A three dimensional image that represents a “store” where avatars within Second Life can interact are created by the software application.
The user can select and identify goods with in the store. For example, there are computer generate images defined as “virtual candies” with specific properties and attributes. For example,
   An image represents a brand of candy or a type of candy.
   A brand of candy can be purchased through Linden dollars.
Create a set of rules based on the transfer or exchange of those “Virtual Candies”:
   Assign a point system to an action. For example,
      Giving someone a brand or type of candy is X Linden Dollars.
      Obtaining a brand or type of candy is Y Linden Dollars.
      “Eating” a brand or type of candy means the Candy can no longer be transferred.
      “Eating” a Candy means you can trade the Virtual Candy for a real candy.

Third Party

A sponsor will agreed on a payment process to the Software owner based on specific actions carried out by the user using the application. Examples of such payment process include:
Fixed payment for using the three dimensional image to represent a specific brand of candy.
A payment schedule based application transactions. For example,
   A payment that is a function of the number of users and/or the number virtual candy purchased with Linden Dollars in the Second Life at a given time period.
   A payment based on the number or type of candy being “eaten”.
An exchange of goods based on application transactions. For example,
   An exchange of real candles provided by the sponsor based on the amount of virtual candy a user has eaten.

User

A user of this “Virtual Store” application will find this application when the user is on the Second Life network. The user will use the application as developed by the System Administrator s with the action being monitored and paid for by the sponsor.

### Example 4

### Virtual Shopping

One embodiment of the present invention involves a system for selling that could involve a real or virtual store (a Nike Store is an example of a real store and Amazon is an example of a virtual store), whereby an initial user purchases products and/or services and such purchasing information is used by said store to influence or cross promote further purchases by members of the initial user's social network.

A specific example for the present invention is demonstrated with reference to the social network system Facebook (e.g. The users Friend list representing the social network). The initial user of Facebook would install an application which would have links or search tools to locate any product and/or service of any kind.

System Administrator

System Administrator develops a web-based application that represents a shopping process. User on a social network can browse items with their friends and buys those items online. Each step of the shopping process becomes a “Subscribed Action”.

Third Party

One Third Party, A, decides to pay for the following “Subscribed Action”:
1. Items in Shopping Process are representative of real world items defined by A.
2. A receives information and order when a User buys an item.

Another Third Party, B, decides to pay for the following “Subscribed Action”:
1. When a User buys a product, they have to use “B”.

User

Since this is an application on a social network, the User can input Settings allowing the user to control the following parameters:
1. Private shopping. No information is sent to another User on the Social Network.
2. By invitation. Shopping with one or more friends on the Social Network through a communication.
3. Social Network Shopping. Shopping with strangers who are also on the social network but not directly related to the User.
4. Network Shopping with help. Shopping with help obtained from the application.

Based on those parameters, the User can then carry out the activity provided by the application on a social network. For example, User invites two of his friends to shop within the software application. The User and his friends sees items from A, they decide to buy one of those items using the method of B. As a result of those actions from the User and his friends, Third Party (A, B) now pays the System Administrator.

### Example 5

### Donations/Sponsorships/Charities

One embodiment of the present invention involves a system for soliciting donations, sponsorships or charities.

A specific example for the present invention is demonstrated with reference to the social network system Facebook (e.g. The users Friend list representing the social network). The initial user of Facebook would install an application which would provide information for donating or sponsoring a charity or volunteer organization.

System Administrator

System Administrator develops a web-based application that represents a donation or volunteering process. The subscribed action is the ability to donate online.

Third Party

Third Party agrees to the subscribed actions and pays if:
1. A donation is made from a user.
2. Once a user donates, his friends are also aware of the user's actions.

User

User Settings allows the user to control the following parameters:
1. Private donation. No information is sent to another User on the Social Network.
2. Encourage Friends. Allows Users on the Social Network to see the donation activity.

Based on those parameters, the User can then carry out the activity provided by the application on a social network. For example, the user uses the application to donate to the Third Party. This automatically triggers a message to his friends that he has donated. Since the conditions for the subscribed actions are met, the Third Party then pays the System Administrator.

### Example 6

### Popularity and Fame

One embodiment of the present invention involves a system for promoting popularity or fame within a social network.

A specific example for the present invention is demonstrated with reference to the social network system Facebook (e.g. The users Friend list representing the social network). The initial user of Facebook would install an application which would provide information on the number of social relationships that exist for the User,

System Administrator

System Administrator develops a web-based application that shows how many online relationships exist for the User and the activities of this User. User on a social network can now determine who is popular or “famous”. Achieving a certain level of fame is a “Subscribed action” within the software.

Third Party

A Third Party agrees that anyone using the application and reaches a threshold of “Fame” receives a payment of $5 from the Third Party. In addition, the Third Party pays the System Administrator each time a user claims that $5.

User

User Settings allows the user to control the following parameters:
1. Privacy—allow other users to know this measure or allow others to know about the User's activity.

Based on those parameters, the User can then carry out the activity provided by the application on a social network. The User reaches a certain level of fame and gains his price from the Third Party. This triggers a payment from the Third Party to the System Administrator.

The foregoing embodiments of the invention are examples and can be varied in many ways. Such present or future variations are not to be regarded as a departure from the spirit and scope of the invention, and all such modifications as would be apparent to one skilled in the art are intended to be included within the scope of the following claims.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

1. A system for associating benefit to activities of a computing system comprising:
a computing system having one or more subscribable actions, each subscribable action associated with one or more functionalities of the computing system;
means for associating one or more party parameters with any of the one or more subscribable actions, the one or more party parameters being associated with one or more third parties; and
means for detecting when a subscribable action has been triggered by one ore more first users; and
means for recording information relating to triggered subscribable actions comprising: the one or more subscribable actions, the one or more first users or a combination thereof.

2. A system for influencing behaviour of one of more second users of a computing system comprising:
a computing system having one or more subscribable actions;
means for detecting when any of the one or more subscribable actions is triggered by one or more first users; and
means for communicating or making available to the one or more second users of the computing system information relating to: the one or more first users, the associated subscribable action, or a combination thereof.

3. The system of claim 2, wherein the one or more subscribable actions may be associated with additional information, activity or events, the additional information, activity or events being associated with one or more third parties.

4. The system of claim 1, wherein the computing system comprises one or more social networks, one or more communication networks comprising one or more computing devices, one or more software applications, or any combination thereof.

5. A method for associating benefit to activities of a computing system comprising:
providing to one or more first users access to a computing system having one or more subscribable actions, each subscribable action associated with one or more functionalities of the computing system;
associating one or more party parameters with any of the one or more subscribable actions, the one or more party parameters being associated with one or more third parties;
detecting when a subscribable action is triggered by the one or more first users; and
recording information relating to the one or more subscribable actions, information relating the one or more first users, and information relating to the one or more associated party parameters.

6. A method for influencing behaviour of the users of a computing system comprising, the method comprising the steps of:
providing a computing system having one or more subscribable actions;
detecting when a subscribable action is triggered and recording information relating to the subscribable action and the one or more users that triggered the subscribable action; and
communicating or making available to one or more second users information relating to: the one or more first users of the computing system, the subscribable action, or a combination thereof.

7. The method of claim 6, wherein the one or more subscribable actions may be associated with one or more party parameters, the one or more party parameters being associated with one or more third parties.

8. The method of claim 5, wherein the computing system comprises one or more social networks, one or more communication networks comprising one or more computing devices, one or more software applications, or any combination thereof.

9. The system of claim 2, wherein the computing system comprises one or more social networks, one or more communication networks comprising one or more computing devices, one or more software applications, or any combination thereof.

10. The system of claim 3, wherein the computing system comprises one or more social networks, one or more communication networks comprising one or more computing devices, one or more software applications, or any combination thereof.

11. The method of claim 6, wherein the computing system comprises one or more social networks, one or more communication networks comprising one or more computing devices, one or more software applications, or any combination thereof.

12. The method of claim 7, wherein the computing system comprises one or more social networks, one or more communication networks comprising one or more computing devices, one or more software applications, or any combination thereof.
